(19) United States
(12) Patent Application Publication
(10) Pub. No.: US 2005/0128870 A1
(43) Pub. Date: Jun. 16, 2005

(54) Device for assembling two tubular elements and tubular elements therefor

(76) Inventor: Thierry Garcia, Rambouillet (FR)

Correspondence Address: YOUNG & THOMPSON, 745 SOUTH 23RD STREET, 2ND FLOOR, ARLINGTON, VA, 22202, US

(21) Appl. No.: 10/505,011

(22) PCT Filed: Feb. 19, 2003
(86) PCT No.: PCT/FR03/00545

(30) Foreign Application Priority Data
Feb. 19, 2002 (FR) 02/02066

(51) Int. Cl. B01F 15/00; B65D 41/06; B65D 41/36

(52) U.S. Cl. 366/347; 220/301

(57) ABSTRACT

A device for assembling together two tubular elements assembled by partial relative coaxial rotation, includes first and second guiding and mating elements arranged on the surfaces designed to be urged opposite the tubular elements to be connected. The first and second guiding elements include a plurality of inclined ramps in the closing direction and brought into pressure contact when the two tubular elements move coaxially relative to each other, and the first mating elements include a plurality of locking blocks arranged in the inner wall of the overlapping tubular element and respectively between the two sloping ramps adjacent the covering tubular elements, one outer surface of each of the blocks being urged to be positioned beneath the second mating elements of the covered tubular element.

The present invention relates to a device for assembling two tubular elements as well as tubular elements permitting the use of such an assembly device.

Assembly by partial covering of two tubular elements assembled or disassembled by partial relative coaxial rotation, is known at present. The most conventional solution consists in providing, on the internal wall of the covering tubular element, and the external wall of the covered tubular element, a helicoidal screw thread, continuous or not, to permit axial assembly by screwing as shown in German patent DE-A-704.203. However, this solution is not sufficiently robust in the case of bodies of metallic receptacles because the screw threads disposed on the external wall of the body are continuously exposed to the risk of degradation from the environment. However, these receptacle bodies are very widespread and used for decades, in particular in the field of packaging coating products such as paints. These metallic receptacles are generally of cylindrical shape, of very different heights and diameters as a function of the regions of the world and have a large variety of rims seated on their upper portion. These rims have more or less complicated profiles to ensure both the rigidity of the top of the box and the seating by pressing of a metallic disk serving as a cover to close the packaging.

In this particular field of paints, moreover, the cover can be of complicated design, in particular when it integrates a stirring device and opening/closing means of a pouring spout. These stirring and/or pouring covers have always had the problem of being adaptable to the very great variety of the flanges of containers whilst guaranteeing good sealing. Thus, these stirring and/or pouring covers are widely used in the paint industry and for the final user. The goal in the years to come consists in providing a packaging adapted to be independent of a flange whilst offering a universal assembly portability for all types of covers that cam be used at any time during the life of a container.

Other solutions resorted to until now, in particular in the specific field of packaging paints, are of several types.

The first solution which is the most widespread and disclosed in particular in French patent 2.555.141 consists in using several rotatable cams positioned within the cover, these cams coming into an angular position to be located below a flange with which the upper edge of the container is provided. This solution leads inevitably to a contact between the locking member and the product such as paint contained within the receptacle. Moreover, it is complicated to provide and requires vertical mobility of the cams to avoid friction which damages the protective coating of the flanges of the container particularly for water-based paints. There moreover is a requirement to guarantee the sealing of the stirrer and/or pourer cover which, to permit the passage of the control axes by movement of these cams, is pierced with openings. It will also be seen that the point-wise securement ensures relatively certain sealing about the perimeter of the upper edge of the cam by means of a sophisticated and voluminous joint which can absorb the variations of geometry of the flanges.

Another solution, which has the advantage of being external to the cover, is described in French patent 2.675.775. This assembly device is thus constituted by arches articulated to the base of the body of the receptacle, these arches having snap-fitting engagement in grooves in the upright wall of the stirrer and/or pourer cover to avoid the traditional connection principle by cams which is most common in the paint sector. But this device is relatively cumbersome and can give rise to untimely opening in the course of handling the assembly of the can and cover.

French patent 2.538.349 discloses a device for resilient assembly in which the cover is provided with tongues that grip the lower part of an annular rim of the body of the receptacle. Again, such a device does not permit obtaining sufficient gripping forces to guarantee an effective assembly. Moreover, it proposes the replacement of the cams by another mechanical connection system which is altogether as complex.

There is also known from U.S. Pat. No. 2,257,370 a cam assembly which is characterized by its complexity.

Finally, there is known from European patent 1 153 844 a screw assembly requiring the addition of a screw-threaded ring on the periphery of the receptacle. The closing or opening of the tapped cover requires several rotational turns of the cover.

An object of the present invention is to provide a new assembly device and new tubular elements assembled by means of such a device, which permits the blind assembly about a fraction of a turn whilst ensuring excellent mechanical gripping uniformly distributed about the periphery of the assembly zone.

Another object of the present invention is to provide an assembly device and tubular elements assembled by means of such a device whose design permits generating radial and axial gripping forces ensuring on the one hand, by their orientation, a reinforcement of the sealing of the assembly, and on the other hand, by off-centering or rendering eccentric radial forces, a reinforcement of the gripping so as to prevent any untimely disassembly.

Another object of the present invention is to provide an assembly device and tubular elements assembled by means of such a device whose design permits continuously maintaining accessible the assembly means so as to be able to act on these latter, other than by an action of rotation, in particular in the case in which the content of one of the tubular elements has led to a blockage of disassembly.

Another object of the present invention is to provide a new solution for packaging associating a can and a cover without any supplemental mechanical means other than the use of profiled inertion sectors such that they permit ensuring direct connection between the external body of a covered tubular element and the internal body of a tubular covering element.

Another object of the present invention is to provide a simplified assembly device which will be as economical as possible in particular between a stirrer and/or pouring cover and a can by omitting the securement cams which have the drawback of reducing the sealing performance of the stirrer and/or pouring cover, of degrading the protective internal coverings of the metallic receptacles favoring the appearance of rust, of requiring much less time to emplace the stirrer and/or pouring cover on a can.

Another object of the present invention is to provide a device for assembling between a stirrer cover and a metallic can permitting the omission of the upper flange of a can to ensure total emptying of the contained paint of the can.

To this end, the invention has for its object an assembly device between two tubular elements such as a receptacle body and a partial or a total closure member, assembled or disassembled by partial relative coaxial rotation, this device being constituted on the one hand by first and second coupling means, on the other hand by first and second guide means respectively disposed each time on the respective internal and external surfaces adapted to come into opposition of the tubular elements to be connected, characterized in that the first and second guide means are constituted by a plurality of guide ramps inclined in the direction of closure and brought into bearing contact during relative coaxial movement in rotation of the tubular elements to give rise to axial covering of said tubular elements and in that the first coupling means are constituted by a plurality of locking lugs provided in the internal wall of the covering tubular element and disposed respectively between two adjacent inclined ramps of the covering tubular element, one external surface of each of said lugs coming, in the course of the assembly in the superposed condition of the covering element and the covered element, into position below a second coupling means of the covered tubular element to give rise to radial and axial gripping of the connected tubular elements.

According to a preferred embodiment of the invention, the covering tubular element has the general shape of a cover, the top of this cover having openings disposed in line with the locking lugs to give to the covering wall of the cover a radial elasticity contributing to the radial and axial gripping of the lug with the second coupling means of the covered tubular element.

The presence of openings provides a number of important advantages. In permits in particular creating an elasticity at the gripping point or contact point to give rise to supplemental holding forces by friction of the surfaces which promotes a wedging effect. The mechanical forces are eccentric such that the covering tubular element can in no case become freed without voluntary action. Moreover, this elasticity permits prepping the surfaces in contact to remain assembled under all circumstances thanks to mobility in the space from the gripping zone. Finally, these openings permit, in certain configurations of the sealing means, contributing to this sealing. Finally, they permit carrying out disassembly of the tubular elements when for example the tubular elements serve for the packaging of products adapted to dry out, such as paint, the drying giving rise to blocking of the disassembly. The engagement of a flat tool through the openings then permits un-sticking the contact locking surfaces which remain completely accessible. Finally the openings can constitute windows for visual indication to give information on the open/closed positions. Furthermore, these openings facilitate the production of a resilient locking lug with counter-clearance without complicating the industrial process.

The invention also has for its object a tubular covering element such as a cover, assembleable or dis-assembleble by partial reciprocal rotation with a covered tubular element, such as the body of a receptacle, particularly by means of an assembly device of the mentioned type, this element comprising guide means and coupling means disposed each time on the surface of said element adapted to come into facing relation with a surface of the tubular element to be connected, characterized in that the guide means are constituted by at least one guide ramp inclined in the closing direction and brought into bearing contact with a complementary guide ramp of the covered tubular element during relative rotational coaxial movement of the tubular element to cause an axial covering of said elements and in that the coupling means of the covering tubular element are constituted by a plurality of locking lugs provided in the internal wall of the tubular covering element and disposed respectively between two inclined guide ramps forming the guide means, an external surface of said lugs coming, during the course of assembly to the superposed condition of the covering element and of the covered element, into position below coupling means carried by the covered tubular element to give rise to radial and axial gripping of the connected tubular elements.

The invention also has for its object a covered tubular element, such as the body of a receptacle, assembleable or dis-assembleable by partial relative coaxial rotation with a covering tubular element such as a cover, this covered tubular element comprising guide means and a coupling means disposed in each instance on the surface of the element adapted to come into opposition with a surface of the covering tubular element, characterized in that the guide means and coupling means are of the covered tubular element, arranged to permit the use of an assembly device of the mentioned type, are present in the form of a plurality of sectors of progressive section provided on the external surface of the wall of the covered tubular element to define respectively a flat guide surface substantially normal to the wall of the covered tubular element and an assembly face inclined relative to the wall of the covered tubular element, said sectors being oriented on the wall and the covered tubular element in the manner of an interrupted screw thread, the profile of the inclined assembly surface of said sectors being profiled to match an external contact surface of a locking lug of the covering tubular element, this lug coming into position, in the course of assembly in the superposed position of the covering element and the covered element, below said inclined surface to cause a radial and axial gripping of the connected tubular elements.

The invention will be better understood from a reading of the following description of examples of embodiment, with reference to the accompanying drawings, in which:

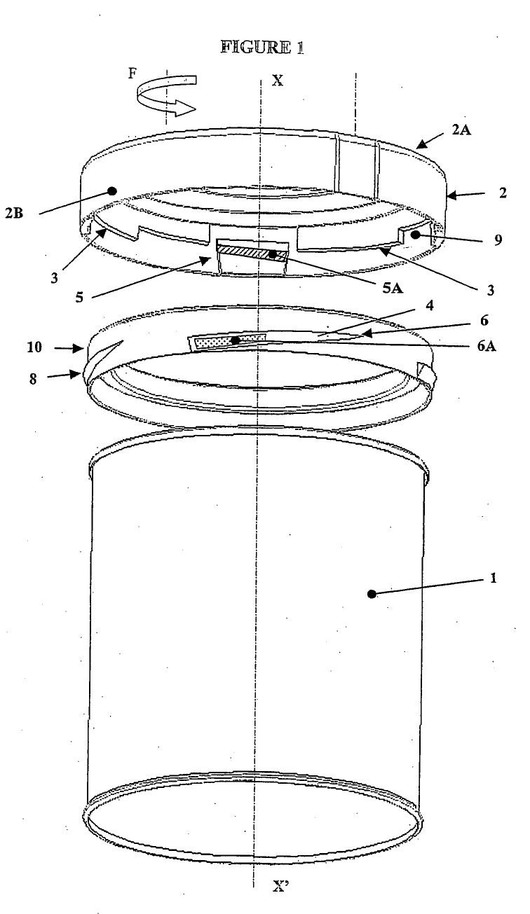

FIG. 1 is a perspective view, in an unassembled condition, of a tubular element adapted to be assembled with another tubular element by means of an assembly device according to the invention;

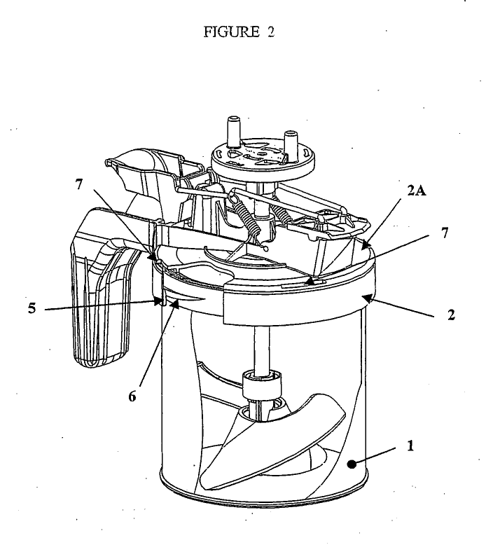

FIG. 2 is a partially perspective and partially transparent view of a tubular element in the condition assembled by means an assembly device according to the invention, the covering tubular element being constituted by a stirring cover;

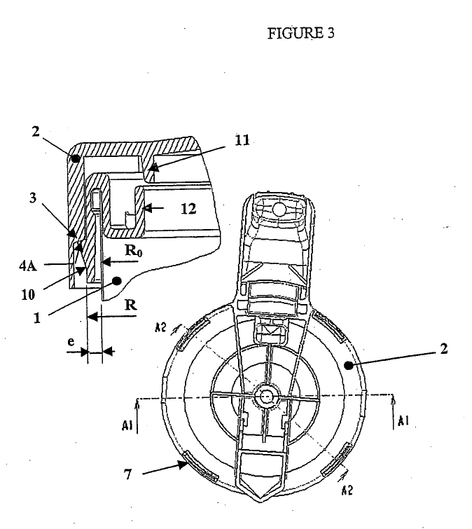

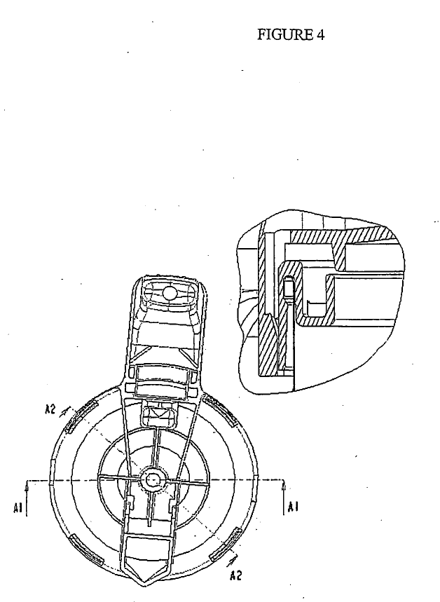

FIGS. 3 to 6 show in each case a view from above the tubular covering element in the assembled condition with the covered tubular element and a view in partial cross-section of the assembly device in positions corresponding respectively to the beginning of assembly, an intermediate position of assembly, a contact position, then a gripping position;

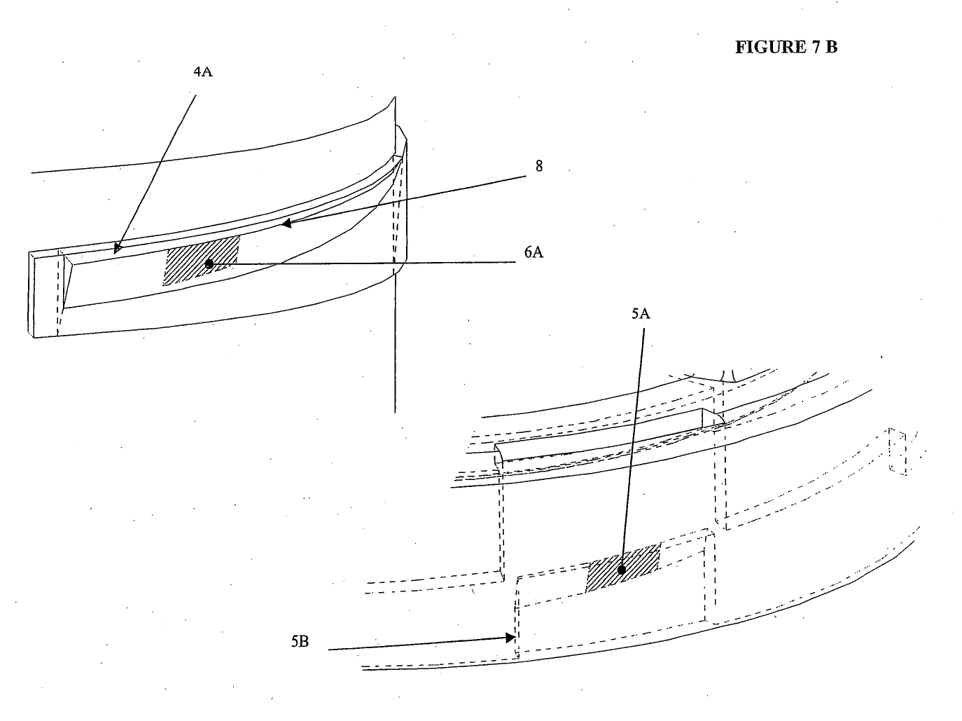

FIGS. 7A and 7B show schematic views of the first and second coupling means and of the second guide means of the assembly device;

FIG. 7C is a schematic view of a modified assembly device of FIGS. 7A and 7B, a detail of the cover having been enlarged; and

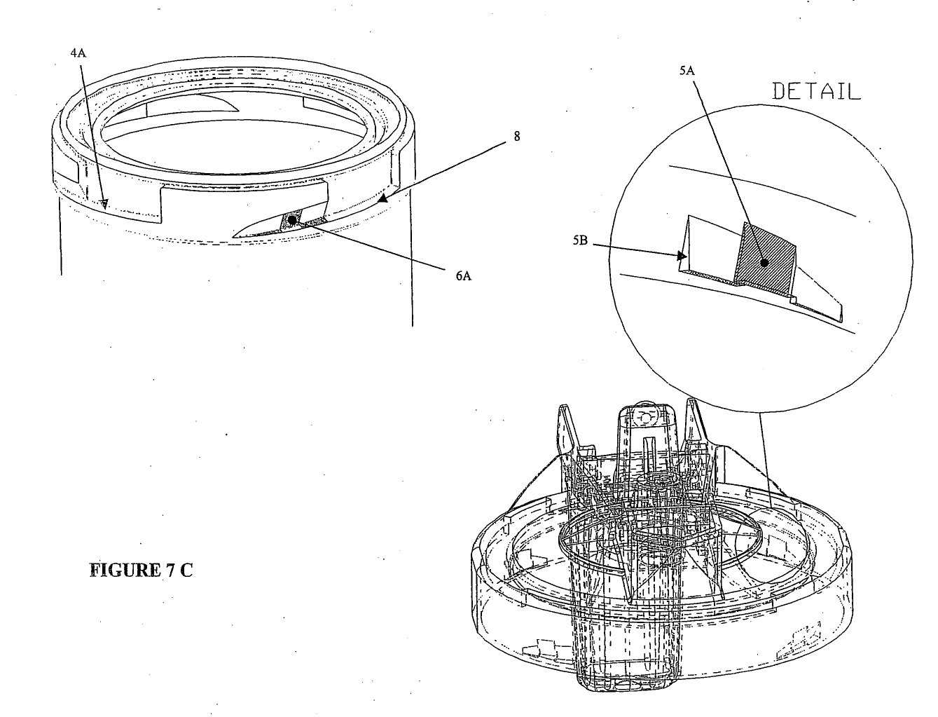

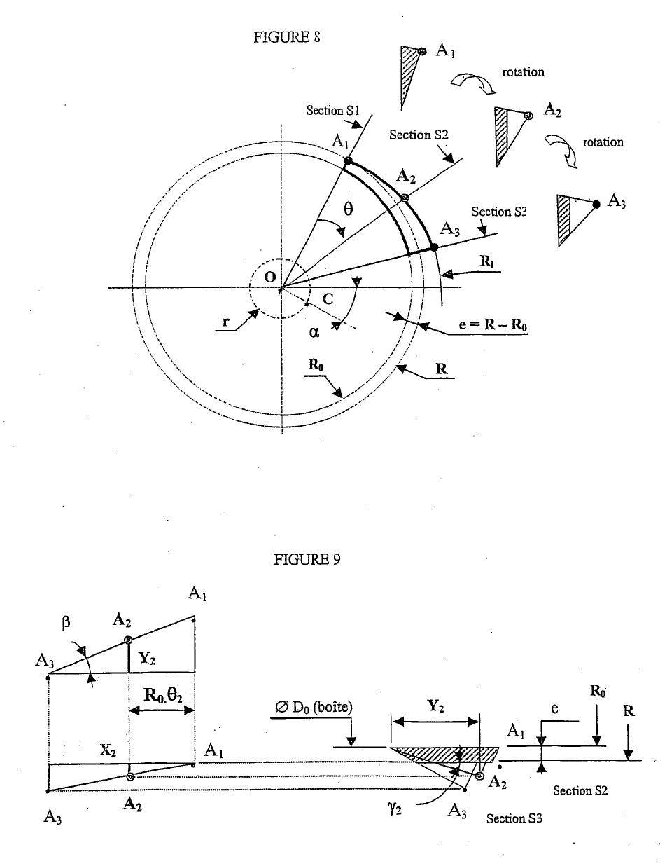

FIGS. 8 and 9 are mathematical models and geometric configurations of the second means for guiding and coupling of the assembly device.

The assembly device according to the invention is adapted for the assembly of two tubular elements 1, 2 assembled and disassembled by partial relative coaxial rotation. These tubular elements 1 and 2 can be constituted, by way of example, by a receptacle body and by a partial or total closure member such as a cover. In the examples described hereafter, reference will more particularly be had to a receptacle body and a cover adapted in particular to the sealed packaging of paint, the cover being adapted to be a stirring and/or pouring cover incorporating a pouring spout closable by means of a suitable closure device incorporated in the cover.

The assembly device is constituted by on the one hand first and second coupling means 5 and 6, on the other hand first and second respective guide means 3 disposed in each instance on the respective exterior and interior surfaces adapted to confront each other of the tubular elements 1, 2 to be connected. In the given examples, the first coupling means 5 and the first guide means 3 are provided in the covering tubular element 2 constituted by the cover of the receptacle on the internal surface of the overlying wall of the cover, whilst the second guide means 4 and the second coupling means 6 are provided on the external wall of the body 1 of the receptacle either directly on this wall, or on a ring 10 connected to this receptacle wall as shown in FIG. 1. In the first case, the guide means 4 and coupling means 6 can be made of a single piece with the body of the element. It is to be noted that this tubular covered element 1 can be made of a number of materials, in particular of metal. In the case in which the guide means 4 and the coupling means 6 are provided on a ring 10 connected to the body of the covered tubular element 1, the ring can again be made of metal or of a synthetic material. In the same way, the first guide means 3 and coupling means 5 can be made of a single piece with the covering tubular element 2 as shown in the drawing or be made in the form of an added piece.

In the illustrated examples, the first and second guide means are constituted by a plurality of guide ramps 3 and 4 inclined in the closing direction, these guide ramps being brought into bearing contact during relative rotational coaxial movement of the tubular elements 1, 2 to give rise to axial overlapping of the tubular elements 1, 2. It is to be noted that by the direction of closing is meant a movement in rotation of the elements in a direction leading to the assembly of said elements, whilst the opening direction corresponds to a relative rotational movement of the elements bringing them to a disassembled position. The axis of rotation about which the elements 1 and 2 move is represented by X, X′ in FIG. 1. The direction of rotation or the closing direction corresponds to an assembly of the tubular elements 1 and 2 and in this case in the clockwise direction shown by arrow F and which corresponds to the usual practice of users. The guide ramps are thus disposed at intervals about the internal periphery of the covering tubular element 2 and on the external periphery of a covered tubular element 1. These ramps are constituted in each instance by surfaces normal or substantially normal to the walls of the bodies, these surfaces being developed along a helix about the body.

The assembly device comprises, in addition to the first and second guide means, first and second coupling means. The first coupling means are constituted by a plurality of locking lugs 5 provided in the internal wall of the covering tubular element 2. Each locking lug 5, projecting from the internal wall of the covering tubular element 2, in the direction of the interior of said element 2, is disposed in each instance between two inclined guide ramps 3 forming the first guide means for the covering tubular element 2. Each lug 5 is offset axially relative to the inclined ramps 3. Preferably, the number of ramps is equal to the number of lugs. An external surface 5A of lug 5 tends, in the course of assembly, into superposed relation with the covering element 2 and the covered element 1 as shown in the figures, positioning itself below the second coupling means 6 of the covered tubular element 1 to provide a radial and axial gripping of the connected tubular elements 1, 2.

In the case in which the covering tubular element 2 is a body closed by means of a wall 2A from above and thus has the general shape of a cover, the top 2A of this cover has openings 7 disposed in line with the locking lugs 5. These openings 7 give to the covering wall 2B of the cover 2 a radial elasticity contributing to the radial and axial gripping of the lug 5 with the second covering means 6 of the covered tubular element 1. There result from the presence of these openings 7 a large number of advantages as mentioned above. Thus, these openings 7 permit particularly access to the first and second coupling means, particularly by introduction of a flat tool through the openings 7. This thus permits helping the uncoupling of said coupling means when for example an action in rotation does not suffice to cause the unlocking of said elements. This impossibility of unlocking can be due to the presence of material on said walls, material which has been able to dry. This can be in particular the case when the receptacle is adapted for the packaging of paint which can, in the course of the operations of opening and closing the cover, become spread over the first and second coupling means.

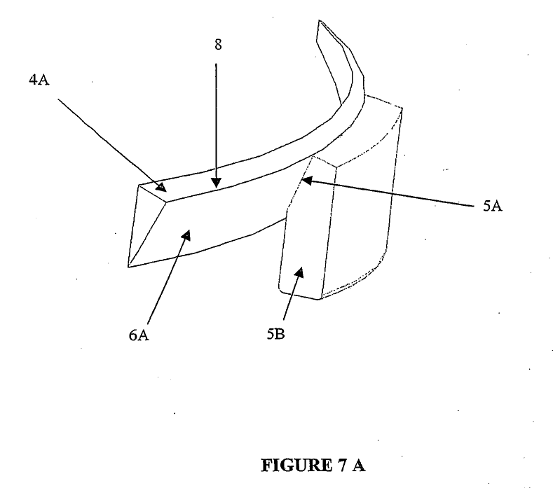

Moreover, the resultant of the axial and radial gripping forces, inclined in the direction of the central longitudinal axis of the tubular elements, can contribute to reinforcing the sealing, in particular in the case of sealing obtained according to the embodiments shown in FIGS. 3 to 6. Thus, in this case, the cover is provided with a truncated conical annular rib 11 adapted to be inserted within a cavity of the receptacle body, which cavity is delimited by means of a flange 12 positioned adjacent the upper edge of the receptacle body. It will thus be noted that the resultant of the axial and radial forces permits reinforcing the pressure of the wall of the flange against the external wall of the sealing rib. Finally, this elasticity which is thus conferred to the walls permits, in the course of gripping, obtaining a grip such that the exerted radial gripping forces are eccentric relative to the center of the tubular elements, as shown in FIG. 6, thereby preventing any untimely disassembly of the tubular elements 1 and 2.

As shown more particularly in FIGS. 1 and 7A, the guide means 4 and coupling means 6 of the covered tubular element 1, called second guide and coupling means, are present in the form of a sector with a progressive cross-section provided on the external surface of the wall of the covered tubular element 1 to define a guide surface 4A that is flat and normal or substantially normal to the wall of the covered tubular element 1 and coacting with the first guide means 3 of the covering tubular element 2 and an assembly surface 6A inclined relative to the wall of the covered tubular element 1. The sector is oriented on the wall of the covered tubular element 1 in the manner of an interrupted screw thread.

It will thus be seen, as shown in the modeling shown in FIG. 8, that the sector constituting the second coupling means 6 of the covered tubular element 1 has a triangular cross-section with a progressive cross-section in the direction of closing (see section S1, section S2, section S3) with a base bearing against the external wall of the covered tubular element 1 and a projecting spiral helicoidal edge 8 (A₁, A₂, A₃) separating the guide surface 4A from the assembly surface 6A. The triangular cross-section of the sector constituting the second coupling means 6 of the tubular element increases such that the angle of clearance γ formed between the wall of the covered tubular element 1 and the assembly surface 6A increases and is comprised between 20° and 30°, preferably about 25°, in the zone of contact between the first and second coupling means. This point of contact corresponds to the point A₂ in the illustrated examples, the angle being called in this case Y₂. FIG. 9 shows in particular the projection of the surfaces with the cover. It shows particularly a top plan view as well as a front view of the projected profile. Thus, in these examples, θ₂ corresponds to the angle of rotation of the cover between A₁ and A₂ expressed in radians, β to the helix angle, X₂ to the radial distance between A₁ and A₂, Y₂ to the axial distance between A₁ and A₂, R₀ to the initial radius of the tubular element 1, R to the radius of the element 1 either after radial expansion of the zone of the element adapted to comprise the guide and coupling means of the covered tubular element 1, or after positioning of a ring on the element 10 adapted to receive the guide and coupling means, A to the center of the circle delimiting the wall of the element 1, e to the difference between R and R₀, and C to the offset center of r and of an angle α of the circle corresponding to the arc of a circle of radius Rᵢ defined b the points A₁, A₂, A₃, A₂ corresponding to the point of contact of the assembly surface 6A of the profile with the external surface 5A of the locking lug, this assembly surface 6A being inclined at A₂ by an angle γ₂.
X₂=r·cos(α+θ₂)+\sqrt{Rᵢ²−r²·sin²(α+θ₂)}−R=Y₂·tg γ₂
wherein: Y₂=R₀·θ₂ tg β
Namely, at the point of contact A₂: X₂−Y₂·tgγ₂=0
   The connection sectors are thus of triangular cross-section progressively more massive in the direction of closing. This development of the general shape of the profile with a counter clearance leads to an undeformable zone in locking contact under the combined influence of the radial and axial forces. Thus, the beginning of the cross-section is less thick but very wide and its end, in the gripping region, is less wide but more thick. This specific enlargement of the profile is much more resistant to external aggressions and contributes to the creation of a can and cover assembly with high rigidity, in particular in the case where there is no flange seated at the top of the can.

The external surface 5A of contact of the lug 5 with the second coupling means 6 is itself profiled to match the profile of the inclined surface 6A of the sector constituting the second coupling means 6. Generally speaking, the locking lugs 5, provided on the internal surface of the wall of the covering tubular element 2, have respectively the shape of a solid of which at least a portion of the surface of the active external surface 5A that grips, is engendered by the movement of a straight line of progressive inclination γ between the points A1 and A3 to follow the trajectory of two portions of a curve, one an upper spiraled helicoidal one, near the top of the covering tubular element, the other lower elliptical one, said portions of a curve developing in an axially offset manner to the interior of the covering tubular element 2 in a cylindrical sector, the spiraled helicoidal curve developing according to an increasing angle in the direction of closure with reference to the axis of the covering tubular element 2. It is to be noted that the angle of the spiral of the upper curve is identical to that of the helicoidal spiral edge 8 of the covered tubular element 1. Obviously, this surface can be prolonged beyond the spiral curve to have any shape.

In the illustrated example, in particular in FIG. 7A, the locking lugs 5 of the covering tubular element 2 have the shape of a polyhedron with two different lateral trapezoidal surfaces 5B and at least one curved contact surface 5A to match the profile of an inclined surface 6A constituting the second coupling means 6 of the covered tubular element 1. It is to be noted that the upper surface of this polyhedron constitutes an inactive surface and can thus have a large number of shapes.

The covering tubular element 2, such as a cover, will thus comprise guide means 3 and coupling means 5 shaped like those described above. It is to be noted that the guide ramps 3, constituting the guide means of the covering tubular element 2 and which are inclined in the direction of closing and which extend between two adjacent locking lugs 5, have a notch delimiting a clearance 9 permitting sliding of the locking lugs 5 along the coupling means 6 until complete gripping. Moreover, this covering tubular element 2 can, as has already been mentioned above, have a large number of shapes. In the example shown in FIG. 2, the top 2A of the cover 2 comprises a pouring spout and is traversed by a steering device. This cover thus constitutes a steering and/or pouring cover well known to those skilled in this art.

As to the covered tubular element 1 provided with second guide means 4 and second coupling means 6, this covered tubular element 1 can, as has been mentioned above, be made of a large number of materials. It could in particular be made of metal. In this case, the guide means 4 and coupling means 6 could be made of a single piece with the body of the element. The same could be true in the case of a tubular element made of synthetic material. The guide means 4 and coupling means 6 could again be provided on a ring 10 connected to the body of the element, as shown in FIG. 1. In all cases, the different techniques for production could include the use of a cover of the same characteristics. The wall of the element 1 of mean radius R₀ could be extended to a wall of mean radius R equivalent to the wall of the element 10. Thus, the profile could preferably be reduced to the functional portion comprised between the curve (A₁, A₂, A₃) and the cylindrical projection of mean radius R for ease of making the profile of progressive triangular section, particularly of a metallic material in which the maximum drawing of the material must be compatible with the processes of production of the can.

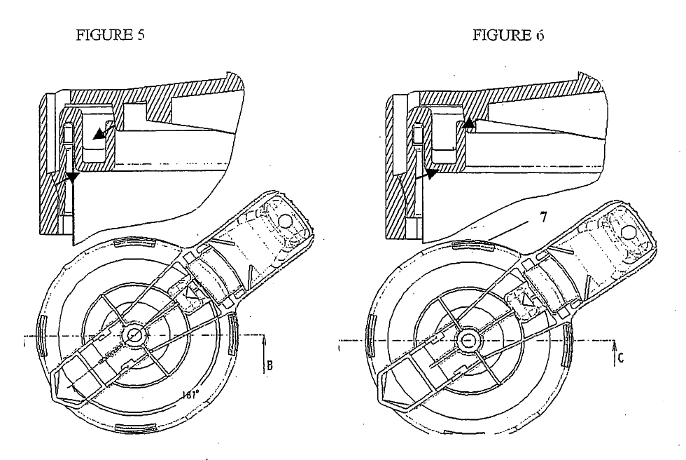

The covered and covering tubular elements described above coact toward assembly or disassembly according to the characteristics shown in FIGS. 3 to 6. FIG. 3 thus shows the beginning of assembly in which the inclined guide ramps 3 and 4 come into bearing contact. During continued rotation corresponding to the intermediate assembly position, each locking lug comes progressively into position below the coupling means 6 of the covered tubular element 1 to reach a contact position represented in FIG. 5 before permitting radial and axial gripping of said walls in contact, this gripping being shown in FIG. 6.

1. Device for assembling two tubular elements (1, 2) such as a receptacle body and a partial or a total closure member, assembled or disassembled by partial relative coaxial rotation, this device being constituted on the one hand by first (5) and second (6) coupling means, on the other hand by first (3) and second (4) guide means respectively disposed in each instance on the surfaces adapted to confront each other of the tubular elements (1, 2) to be connected,
characterized in that the first and second guide means are constituted by a plurality of guide ramps (3, 4) inclined in the direction of closing and brought into bearing contact during coaxial relative rotational movement of the tubular elements (1, 2) to give rise to axial covering of said tubular elements (1, 2) and in that the first coupling means are constituted by a plurality of locking lugs (5) provided in the internal wall of the covering tubular element (2) and disposed respectively between two adjacent inclined ramps (3) of the covering tubular element (2), an external surface (5A) of each of said lugs (5) coming, in the course of assembly to the superposed position of the covering element (2) and the covered element (1), into position below a second coupling means (6) of the covered tubular element (1) to cause a radial and axial gripping of the connected tubular element (1, 2).

2. Device according to claim 1,
characterize in that the covering tubular element (2) has the general shape of a cover, the top (2A) of this cover having openings (7) disposed in line with the locking lugs (5) to give to the covering wall of the cover a radial elasticity contributing to the radial and axial gripping of the lug (5) with the second coupling means (6) of the covered tubular element (1).

3. Device according to claim 1,
characterized in that the guide means (4) and coupling means (6) of the covered tubular element (1), called second guide and coupling means, are present in the form of a sector with a progressive cross section provided on the external surface of the wall of the covered tubular element (1) to define a guide surface (4A) that is flat and normal or substantially normal to the wall of the covered tubular element (1) and coacting with the first guide means (3) of the covering tubular element (2) and an assembly surface (6A) inclined relative to the wall of the covered tubular element (1), said sector being oriented on the wall of the covered tubular element (1) in the manner of an interrupted screw thread.

4. Device according to claim 3,
characterized in that the sector constituting the second guide means (4) and coupling means (6) of the covered tubular element (1) has a triangular cross-section with a base bearing on the external wall of the covered tubular element (1) and a projecting helicoidal spiral ridge (8) separating the guide surface (4A) from the assembly surface (6A).

5. Device according to claim 4,
characterized in that the triangular cross-section of the sector constituting the second coupling means (6) of the tubular element increases such that the angle (γ) of clearance formed between the wall of the covered tubular element (1) and the assembly surface (6A) increases and is comprised between 20° and 30°, preferably about 25°, in the zone of contact between the first (5) and second (6) coupling means.

6. Device according to claim 3,
characterized in that the external contact surface (5A) of the lug (5) with the second coupling means (6) is profiled to match the profile of the inclined surface (6A) of the sector constituting the second coupling means (6).

7. Device according to claim 1,
characterized in that the locking lugs (5) have the shape of a solid of which at least a portion of the active gripping external surface (5A) is defined by the movement of a straight line of progressive inclination to follow the trajectory of two curved portions, an upper spiraled helicoid, near the top of the covering tubular element, the other lower and elliptical, said portions of a curve developing in an axially offset manner within the covering tubular element (2) in a cylindrical sector, the spiral helicoidal curve developing according to an angle increasing in the closing direction with reference to the axis of the covering tubular element (2).

8. Device according to claim 1,
characterized in that the locking lugs (5) of the covering tubular element (2) have the shape of a polyhedron with two lateral trapezoidal surfaces (5B) of different surfaces and at least one curved contact surface (5A) to match the profile of an inclined surface (6A) constituting the second coupling means (6) of the covered tubular element (1).

9. Covering tubular element (2) such as a cover, assembleable or dis-assembleable by partial reciprocal rotation with a covered tubular element (1), such as the body of a receptacle, in particular by means of an assembly device according to claim 1, this element (2) comprising guide means (3) and coupling means (5) disposed in each instance on the surface of said element (2) adapted to confront a surface of the tubular element (1) to be connected,
characterized in that the guide means (3) are constituted by a guide ramp inclined in the closing direction and brought into bearing contact with a complementary guide ramp (4) of the covered tubular element (1) during relative coaxial rotational movement of the tubular elements (1, 2) to give rise to axial overlapping of said elements (1, 2) and in that the coupling means (5) of the covering tubular element (2) are constituted by a plurality of locking lugs provided in the internal wall of the covering tubular element (2) and disposed respectively between two inclined guide ramps (3) forming a guide means (3), an external surface (5A) of said lugs (5) coming, in the course of assembly in the superposed condition of the covering element (2) and the covered element (1), into position below the coupling means (6) carried by the covered tubular element (1) to give rise to radial and axial gripping of the connected tubular elements (1, 2).

10. Tubular covering element (2) such as a cover according to claim 9,
characterized in that the tubular covering element (2) has the general shape of a cover, the top (2A) of this cover having openings (7) disposed in line with the locking lugs (5) to give to the covering wall of the cover a radial elasticity contributing to the radial and axial gripping of each lug (5) with a second coupling means (6) of the covered tubular element (1).

11. Covering tubular element (2) such as a cover according to claim 9,
characterized in that the locking lugs (5) have respectively the shape of a solid of which at least a portion of the surface of the external active locking surface (5A) is defined by the movement of a straight line passing through two portions of spiral curves of different angle developing within the interior of the covering tubular element (2) in two circular confronting sections of said element according to an angle increasing in the direction of closing, the angle of the spiral curve farthest from the guide ramp (3) of the covering tubular element (2) being the angle of the largest value.

12. Covering tubular element (2) such as a cover according to claim 9,
characterized in that the guide ramps (3) inclined in the closing direction and extending between two adjacent locking lugs (5) have a notch delimiting a clearance (9) permitting sliding of the locking lugs (5) along a coupling means (6) up to complete gripping.

13. Tubular covering element (2) such as a cover according to claim 9,
characterized in that the top (2A) of the cover (2) comprises a pouring spout and is if desired traversed by a stirring member.

14. Tubular covering element (1) such as the body of a receptacle assembleable or dis-assembleable by partial relative coaxial rotation with a covering tubular element (2) such as a cover, in particular by means of an assembly device according to claim 1, this tubular covered element (1) comprising guide means (4) and coupling means (6) disposed in each instance on the surface of the element adapted to confront a surface of the covering tubular element (2),
characterized in that the guide means (4) and coupling means (6) of the covered tubular element (1), arranged to permit the use of an assembly device, are present in the form of a plurality of sectors of progressive cross-section provided on the external surface of the wall of the covered tubular element to define respectively a guide surface (4A) that is flat and substantially normal to the wall of the covered tubular element (1) and an assembly surface (6A) inclined relative to the wall of the covered tubular element (1), said sectors being oriented on the wall of the covered tubular element (1) in the manner of an interrupted screw thread, the profile of the inclined assembly surface (6A) of the sectors being profiled to match an external contact surface (5A) of a locking lug (5) of the covering element, this lug coming into position, in the course of assembly to the superposed position of the covering element (2) and the covered element (1), below said inclined surface (6A) to give rise to radial and axial gripping of the connected tubular elements (1, 2).

15. Covered tubular element (1) according to claim 14, characterized in that the guide means (4) and coupling means (6) are made of a single piece with the body of the element.

16. Covered tubular element (1) according to claim 14,
characterized in that the guide means (4) and coupling means (6) are provided on a ring supported on the body of said element.

17. Covered tubular element (1) according to claim 11,
characterized in that it is made of metal and constitutes packaging for liquid products such as paint.
